(19) United States
(12) Patent Application Publication
(10) Pub. No.: US 2026/0026922 A1
(43) Pub. Date: Jan. 29, 2026

(54) FLEXIBLE ELECTRONIC TOOTHBRUSH DEVICE

(71) Applicant: Damian Bolden, Grand Island, NY (US)

(72) Inventor: Damian Bolden, Grand Island, NY (US)

(21) Appl. No.: 18/781,115

(22) Filed: Jul. 23, 2024

(51) Int. Cl. A61C 17/34; A46B 5/00; A61C 17/22

(52) U.S. Cl. CPC A61C 17/3436; A46B 5/0075; A46B 5/0095; A61C 17/221; A61C 17/224; A61C 17/225

(57) ABSTRACT

A flexible electronic toothbrush device includes a toothbrush that has a handle, a tube extending away from the handle and a mounting head attached to the tube. The tube has a flexible portion which is biased into a gentle curve. A brushing head is removably attachable to the mounting head for brushing a user's teeth. A drive unit is integrated into the toothbrush for rotating the brushing head rotated back and forth to brush the user's teeth in a motion preferred by dental health professionals. A straightening unit is movably integrated into the toothbrush for straightening the tube. In this way the straightening unit orients the brushing head at a preferred orientation for brushing the user's teeth without requiring the user to position their shoulder in an orientation that the user cannot achieve.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to electronic toothbrush devices and more particularly pertains to a new electronic toothbrush device for facilitating a physically limited user to brush the back side of their teeth without requiring the physically limited user to position their shoulder in an orientation that they cannot achieve. The device includes an electronic toothbrush that has a flexible portion and a straightening unit integrated into the toothbrush. The straightening unit is urgeable into a straightening position to facilitate the flexible portion of the tube to be straightened. The flexible portion is biased into a gentle curve to orient the head on the tube is oriented at a preferred angle for brushing the back side of the user's teeth.

### (2) Description of Related Art Including Information Disclosed Under 37 CFR 1.97 and 1.98

The prior art relates to electronic toothbrush devices including a variety of electronic toothbrushes that each has a curved neck and a variety of electronic toothbrushes that each has a brushing head that is articulated. In no instance does the prior art disclose an electronic toothbrush device that has a bendable neck and a straightening unit which is manipulated to bend the bendable neck into a preferred orientation for brushing the back side of a user's teeth.

### (h) BRIEF SUMMARY OF THE INVENTION

An embodiment of the disclosure meets the needs presented above by generally comprising a toothbrush that has a handle, a tube extending away from the handle and a mounting head attached to the tube. The tube has a flexible portion which is biased into a gentle curve. A brushing head is removably attachable to the mounting head for brushing a user's teeth. A drive unit is integrated into the toothbrush for rotating the brushing head rotated back and forth to brush the user's teeth in a motion preferred by dental health professionals. A straightening unit is movably integrated into the toothbrush for straightening the tube. In this way the straightening unit orients the brushing head at a preferred orientation for brushing the user's teeth without requiring the user to position their shoulder in an orientation that the user cannot achieve.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a left side view of a flexible electronic toothbrush device according to an embodiment of the disclosure.

FIG. 2 is a right side phantom view of an embodiment of the disclosure.

FIG. 3 is a front phantom view of an embodiment of the disclosure.

FIG. 4 is a back view of an embodiment of the disclosure.

FIG. 5 is a left side phantom view of an embodiment of the disclosure showing a straightening unit being actuated into a straightening condition.

FIG. 6 is a magnified detail view taken from circle 6 of FIG. 3 of an embodiment of the disclosure.

FIG. 7 is a magnified detail view taken from circle 7 of FIG. 2 of an embodiment of the disclosure.

FIG. 8 is a perspective in-use view of an embodiment of the disclosure.

### (j) DETAILED DESCRIPTION OF THE INVENTION

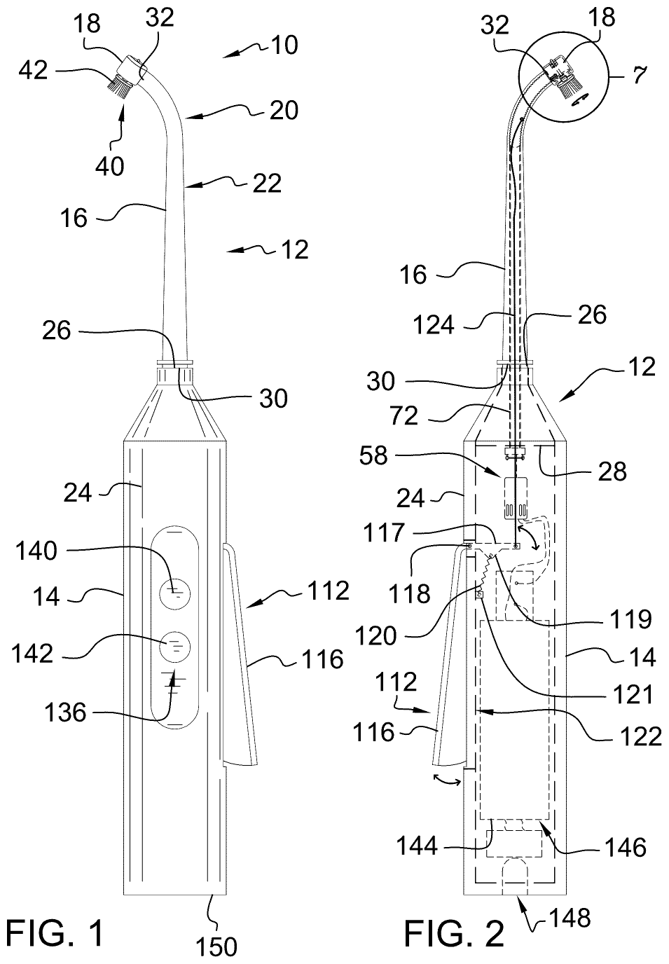

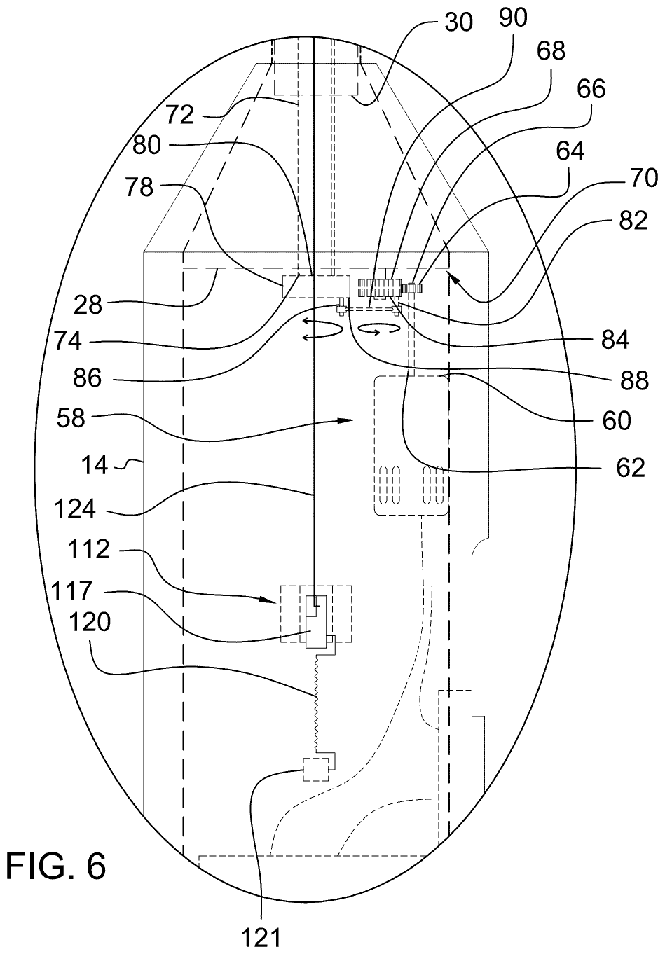

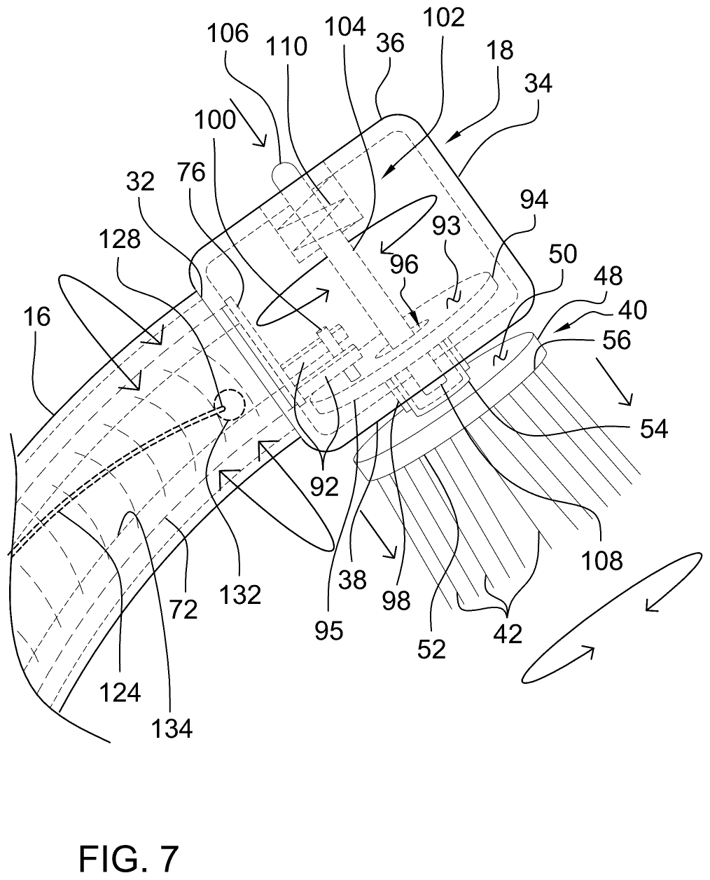

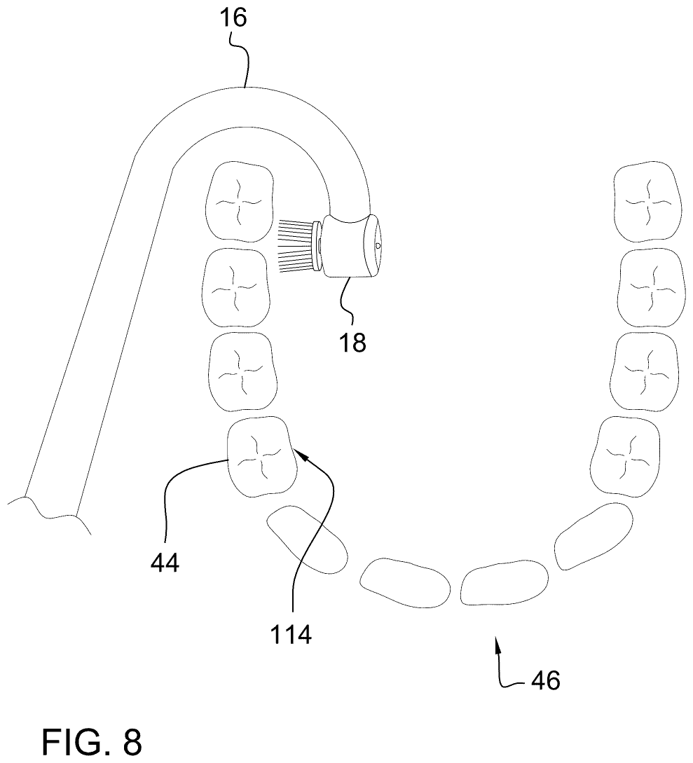

With reference now to the drawings, and in particular to FIGS. 1 through 8 thereof, a new electronic toothbrush device embodying the principles and concepts of an embodiment of the disclosure and generally designated by the reference numeral 10 will be described.

As best illustrated in FIGS. 1 through 8, the flexible electronic toothbrush device 10 generally comprises a toothbrush 12 that has a handle 14 and a tube 16 extending away from the handle 14 and a mounting head 18 attached to the tube 16. The tube 16 has a flexible portion 20 and a non-flexible portion 22; the flexible portion 20 is comprised of a flexible material and the non-flexible portion 22 is comprised of a rigid material. The bendable material of which the flexible portion 20 of the tube 16 is comprised may include, but not be limited to, formed polyethylene-polyvinyl, formed ethylene-vinyl acetate or other material commonly employed for oral hygiene. Furthermore, the flexible material of which flexible portion 20 of the tube 16 is comprised is biased into a gentle curve with respect to the non-flexible portion 22 of the tube 16. The rigid material of which the non-flexible portion 22 is comprised may include, but not be limited to, plastic or hardened rubber.

The handle 14 has an outside wall 24 and an upper end 26 and the outside wall 24 tapers inwardly adjacent to the upper end 26 such that the upper end 26 defines a conical shape. The handle 14 is substantially hollow and the upper end 26 is open. The handle 14 has a dividing wall 28 that is positioned within the handle 14. Furthermore, the dividing wall 28 is spaced downwardly from the upper end 26 of the handle 14 having the dividing wall 28 lying on a plane that is oriented parallel to the upper end 26.

The tube 16 has a bottom end 30 and a top end 32; the bottom end 30 is associated with the non-flexible portion 22 and the top end 32 is associated with the flexible portion 20. A threshold between the non-flexible portion 22 and the flexible portion 20 is located closer to the top end 32 than the bottom end 30 and the upper end 26 of the handle 14 receives the bottom end 30 of the tube 16. The mounting head 18 has an outer surface 34, a top surface 36 and a bottom surface 38 and the outer surface 34 is continuously arcuate about a center of the mounting head 18 such that the mounting head 18 has a disk shape. Additionally, the top end 32 of the tube 16 is attached to the outer surface 34 of the mounting head 18.

A brushing head 40 is removably attachable to the mounting head 18. The brushing head 40 has a plurality of bristles 42 disposed on the brushing head 40 and the plurality of bristles 42 can be employed for brushing teeth 44 of a user 46. The brushing head 40 comprises a brush disk 48 that has an upper surface 50 and a lower surface 52. A receiver 54 is coupled to the upper surface 50 of the brush disk 48 and the receiver 54 is centrally positioned on the upper surface 50. Each of the plurality of bristles 42 has a coupled end 56 that is coupled to the lower surface 52 of the brush disk 48. Furthermore, the bristles 42 are evenly spaced apart from each other and are distributed over a full area of the lower surface 52 of the brush disk 48.

A drive unit 58 is provided and the drive unit 58 is integrated into the toothbrush 12. The drive unit 58 is in mechanical communication with the brushing head 40 when the brushing head 40 is removably attached to the mounting head 18. The drive unit 58 generates an oscillating motion when the drive unit 58 is turned on thereby facilitating the brushing head 40 to be rotated back and forth. In this way the plurality of bristles 42 can brush the user's teeth 44 in a motion preferred by dental health professionals.

The drive unit 58 comprises a motor 60 that is mounted to the outside wall 24 of the handle 14 of the toothbrush 12 such that the motor 60 is positioned inside of the handle 14. The motor 60 rotates in a first direction when the motor 60 is turned on and the motor 60 may comprise a single direction motor 60 or the like. The drive unit 58 includes an output shaft 62 which is coupled to and extends upwardly from the motor 60 such that the motor 60 rotates the output shaft 62 when the motor 60 is turned on. The drive unit 58 includes a first drive gear 64 that is attached to a distal end 66 of the output shaft 62 such that the output shaft 62 rotates the first drive gear 64 when the motor 60 is turned on.

The drive unit 58 includes a second drive gear 68 that is rotatably attached to a bottom side 70 of the dividing wall 28 in the handle 14 of the toothbrush 12. The second drive gear 68 is strategically positioned to enmesh with the first drive gear 64 such that the first drive gear 64 rotates the second drive gear 68 when the motor 60 is turned on. The drive unit 58 includes a cylinder 72 that has a lower end 74 and an upper end 76 and the cylinder 72 is positioned within the tube 16. The cylinder 72 extends through the dividing wall 28 in the handle 14 such that the lower end 74 is spaced downwardly from the dividing wall 28. The upper end 76 extends through the outer surface 34 of the mounting head 18 such that the upper end 76 of the cylinder 72 is positioned inside of the mounting head 18. The cylinder 72 is comprised of a flexible material, including but not being limited to rubber, which has the property of being capable of transmitting rotational torque without deforming along an axis extending between the upper end 76 and the lower end 74 of the cylinder 72. Additionally, the lower end 74 of the cylinder 72 is open and the upper end 76 of the cylinder 72 is closed.

The drive unit 58 includes a cam 78 that has a top side 80 which is coupled to the lower end 74 of the cylinder 72 such that the cam 78 is spaced downwardly from the dividing wall 28. Additionally, the cam 78 is aligned with the second drive gear 68 and the cam 78 is spaced away from the second drive gear 68. The drive unit 58 includes a first peg 82 which is coupled to and extends downwardly from a lower surface 84 of the second drive gear 68. The first peg 82 is offset from a center of the lower surface 84 of the second drive gear 68. The drive unit 58 includes a second peg 86 which is coupled to and extends downwardly from a lower side 88 of the cam 78 and the second peg 86 is offset from a center of the cam 78.

The drive unit 58 includes a linkage 90 that is pivotally attached between the first peg 82 and the second peg 86. The linkage 90 facilitates the cam 78 to be oscillated back and forth each time the second drive gear 68 makes one full rotation. In this way the cylinder 72 is partially rotated back and forth about the axis extending between the lower end 74 and the upper end 76 of the cylinder 72 when the motor 60 is turned on. The drive unit 58 includes a pair of forks 92 and each of the pair of forks 92 is coupled to and extends away from the upper end 76 of the cylinder 72 such that each of the pair of forks 92 is positioned within the mounting head 18.

The drive unit 58 includes a drive disk 94 which is positioned within the mounting head 18. The drive disk 94 has an aperture 96 extending through an upper surface 93 and a lower surface 95 of the drive disk 94 and the aperture 96 is centrally located on the drive disk 94. Additionally, the drive disk 94 lies on a plane that is oriented parallel to the bottom surface 38 of the mounting head 18 having the drive disk 94 being spaced from the bottom surface 38 of the mounting head 18. The drive unit 58 includes a coupler 98 that is coupled to and extends away from the lower surface 95 of the drive disk 94. Additionally, the coupler 98 extends through the bottom surface 38 of the mounting head 18 such that the coupler 98 is exposed with respect to the mounting head 18. The coupler 98 releasably engages the receiver 54 on the brush disk 48 for releasably attaching the brushing head 40 to the mounting head 18. The coupler 98 and the receiver 54 may comprise cups that can be nested within each other and the coupler 98 may include engagements that each releasably engages a respective detent in the receiver 54.

The drive unit 58 includes a finger 100 that is coupled to and extends upwardly from the upper surface 93 of the drive disk 94. Additionally, the finger 100 is offset from the aperture 96 in the drive disk 94. The finger 100 is positioned between the pair of forks 92 which are attached to the upper end 76 of the cylinder 72. The pair of forks 92 urge the finger 100 to travel back and forth when the cylinder 72 is rotated back and forth when the motor 60 is turned on thereby facilitating the drive disk 94 to rotate back and forth. In this way the drive disk 94 rotates the brushing head 40 back and forth when the drive disk 94 is rotated back and forth by the pair of forks 92.

An ejection unit 102 is movably integrated into the mounting head 18 and the ejection unit 102 is in mechanical communication with the brushing head 40 when the brushing head 40 is removably attached to the mounting head 18. The ejection unit 102 is urgeable into an ejecting condition such that the brushing head 40 is disengaged from the mounting head 18. The ejection unit 102 comprises an ejection shaft 104 which extends through the top surface 36 and the bottom surface 38 of the mounting head 18. Furthermore, a first end 106 of the ejection shaft 104 is spaced from the top surface 36 of the mounting head 18 and a second end 108 of the ejection shaft 104 is positioned in the coupler 98 of the drive unit 58 and the ejection shaft 104 extends through the aperture 96 in the drive disk 94.

The ejection unit 102 includes a biasing member 110 that is positioned around the ejection shaft 104 having the biasing member 110 being located within the mounting head 18. The biasing member 110 biases the ejection shaft 104 to travel in a first direction such that the second end 108 of the ejection shaft 104 is spaced from the upper surface 50 of the brush disk 48. The first end 106 of the ejection shaft 104 is depressible such that the ejection shaft 104 is urged to travel in a second direction. Thus, the second end 108 of the ejection shaft 104 presses against the brush disk 48 thereby uncoupling the receiver 54 from the coupler 98 for removing the brushing head 40 from the mounting head 18.

A straightening unit 112 is movably integrated into the toothbrush 12 and the straightening unit 112 is in mechanical communication with the tube 16. The straightening unit 112 is actuatable into a straightening condition such that the tube 16 is straightened. In this way the straightening unit 112 can orient the brushing head 40 at a preferred orientation for brushing the user's teeth 44 without requiring the user 46 to position their shoulder in an orientation that the user 46 cannot achieve. Furthermore, the straightening unit 112 is biased into an un-straightening condition.

The straightening unit 112 comprises a lever 116 which is movably integrated into the outside wall 24 of the handle 14 such that the lever 116 can be manipulated by the user 46. The lever 116 has an arm 117 which extends into an interior of the handle 14 and the arm 117 is perpendicularly oriented with the lever 116. The lever 116 has a pivot point 118 which is located at an intersection between the lever 116 and the arm 117 and the pivot point 118 is pivotally attached to the outside wall 24 of the handle 14. Additionally, the arm 117 has a lobe 119 which extends downwardly from the arm 117. The straightening unit 112 includes a biasing member 120 which is attached between the lobe 119 on the arm 117 and an attachment point 121 located on an interior surface 122 of the outside wall 24 of the handle 14 such that the biasing member 120 on the arm 117 biases the lever 116 into a first position. The lever 116 is compressible against the outside wall 24 of the handle 14 having the lever 116 pivoting on the pivot point 118. In this way the arm 117 is urged to pivot upwardly when the lever 116 is urged into a second position.

The straightening unit 112 includes a member 124 that is comprised of a rigid material, including but not being limited to steel or aluminum. The member 124 has a coupled end 126 and a free end 128 and the member 124 is positioned within the cylinder 72 of the drive unit 58. The coupled end 126 of the member 124 is attached to a distal end 130 of the arm 117 on the lever 116 and a ball 132 is attached to the free end 128 of the member 124 thereby reducing friction between the ball 132 and an interior surface 134 of the cylinder 72 of the drive unit 58. The ball 132 is aligned with the threshold between the flexible portion 20 of the tube 16 and the non-flexible portion 22 of the tube 16 when the lever 116 is biased into the first position such that the flexible portion 20 of the tube 16 is enabled to be biased into the gentle curve.

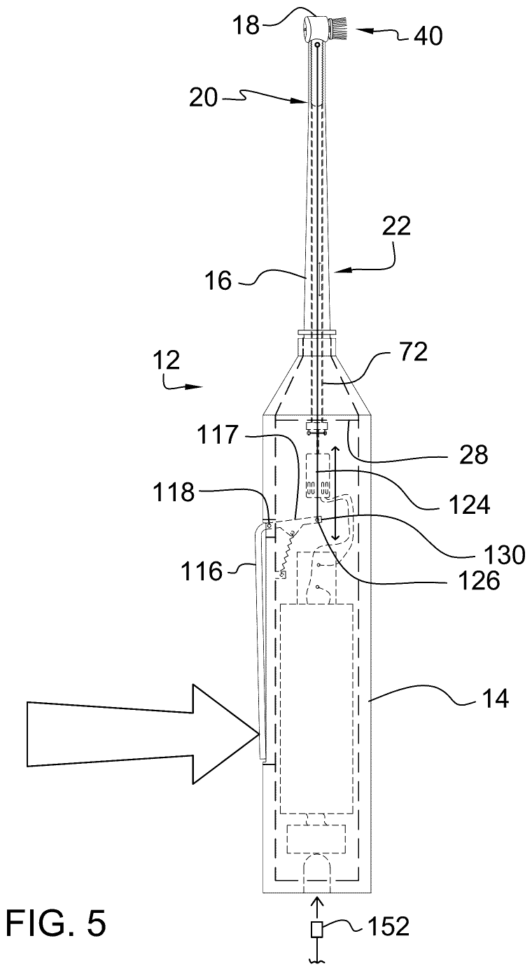

As is shown in FIG. 5, the member 124 is urged to travel upwardly in the cylinder 72 when the lever 116 is urged into the second position having the ball 132 travelling into the flexible portion 20 of the tube 16. In this way the member 124 is facilitated to straighten the flexible portion 20 when the ball 132 travels into the flexible portion 20. Additionally, the user 46 can control the degree to which the flexible portion 20 of the tube 16 is bent by controlling the degree to which the lever 116 is depressed into the second position. For example, the curvature of the flexible portion 20 is reduced when the lever 116 is minimally depressed and the flexible portion 20 is fully straightened when the lever 116 is maximally depressed.

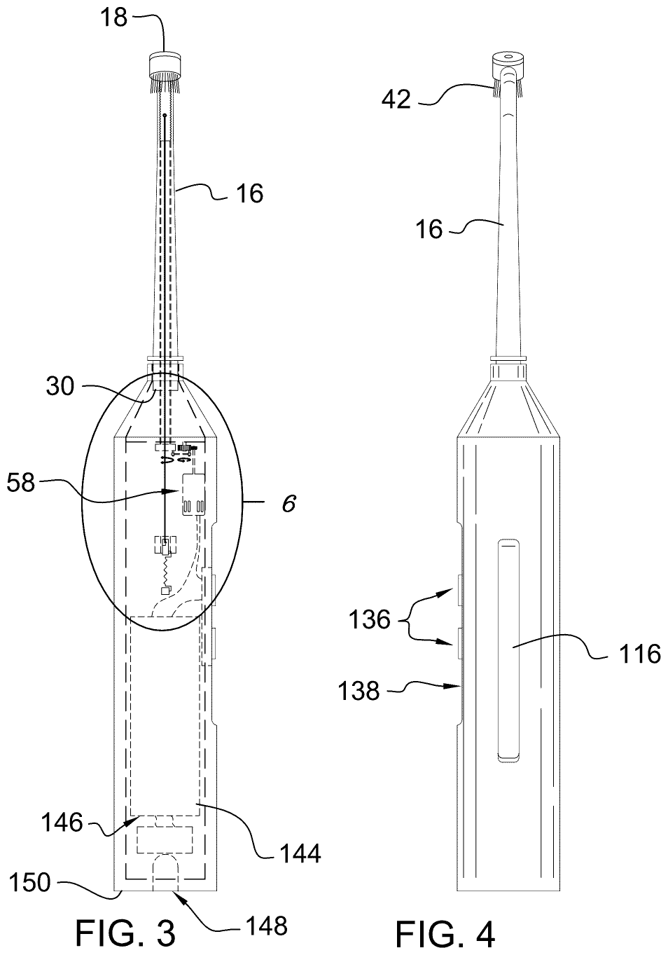

A pair of control buttons 136 is provided and each of the pair of control buttons 136 is movably integrated into the outside wall 24 of the handle 14 of the toothbrush 12 thereby facilitating the pair of control buttons 136 to be manipulated. As is most clearly shown in FIGS. 3 and 4, the outside wall 24 of the handle 14 has a recess 138 and each of the pair of control buttons 136 is positioned in the recess 138. Each of the pair of control buttons 136 is electrically coupled to the motor 60 and the pair of control buttons 136 includes an on button 140 and an off button 142. The motor 60 is turned on when the on button 140 is depressed and the motor 60 is turned off when the off button 142 is depressed.

A power supply 144 is integrated into the handle 14 of the toothbrush 12 and the power supply 144 is electrically coupled to the motor 60. The power supply 144 comprises a rechargeable battery 146 that is positioned within the handle 14 of the toothbrush 12 and the rechargeable battery 146 is electrically coupled to the motor 60. The power supply 144 includes a charge port 148 that is recessed into a bottom end 150 of the handle 14 of the toothbrush 12 to insertably receive a charge cord 152. Additionally, the charge port 148 is electrically coupled to the rechargeable battery 146 for charging the rechargeable battery 146.

In use, the on button 140 is manipulated to turn on the motor 60 thereby rotating the brushing head 40 back and forth for brushing the user's teeth 44. The biasing of the flexible portion 20 into the gentle curve enables the brushing head 40 to be positioned against the back side 114 of the user's teeth 44 without requiring the user 46 to manually position the toothbrush 12 in the required position to brush the back side 144 of the user's teeth 44. In this way the user 46, who may be suffering from limited shoulder mobility due to an injury or disease, can easily brush the back side 114 of their teeth 44 without being required to position their shoulder in an orientation that they cannot achieve. The lever 116 is depressed into the second position thereby facilitating the tube 16 on the toothbrush 12 to be straightened according to the user's preferences. The ejection shaft 104 is depressed to eject the brushing head 40 from the toothbrush 12 thereby facilitating the brushing head 40 to be replaced when the bristles 42 become deformed or otherwise worn from repeated use.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A flexible electronic toothbrush device for facilitating a physically limited user to brush both the front side and the back side of the user's teeth without requiring the user to position the user's shoulder at orientations that the user cannot achieve, said device comprising:
a toothbrush having a handle and a tube extending away from said handle and a mounting head attached to said tube, said tube having a flexible portion being comprised of a resiliently flexible material thereby facilitating said flexible portion of said tube to be biased into a gentle curve with respect to a non-flexible portion of said tube which is comprised of a rigid material;
a brushing head being removably attachable to said mounting head, said brushing head having a plurality of bristles being disposed on said brushing head wherein said plurality of bristles is configured to be employed for brushing a user's teeth;
a drive unit being integrated into said toothbrush, said drive unit being in mechanical communication with said brushing head when said brushing head is removably attached to said mounting head, said drive unit generating an oscillating motion when said drive unit is turned on thereby facilitating said brushing head to be rotated back and forth wherein said plurality of bristles is configured to brush the user's teeth in a motion preferred by dental health professionals;
an ejection unit being movably integrated into said mounting head, said ejection unit being in mechanical communication with said brushing head when said brushing head is removably attached to said mounting head, said ejection unit being urgeable into an ejecting condition such that said brushing head is disengaged from said mounting head; and
a straightening unit being movably integrated into said toothbrush, said straightening unit being in mechanical communication with said tube, said straightening unit being actuatable into a straightening condition such that said flexible portion of said tube is straightened wherein said straightening unit is configured to orient said brushing head at a preferred orientation for brushing the user's teeth without requiring the user to position their shoulder in an orientation that the user cannot achieve, said straightening unit being biased into an un-straightening condition.

2. The device according to claim 1, wherein:
said handle has an outer wall and an upper end;
said outer wall tapers inwardly adjacent to said upper end such that said upper end defines a conical shape;
said handle is substantially hollow;
said upper end is open;
said tube has a bottom end and a top end;
said bottom end is associated with said non-flexible portion;
said top end is associated with said flexible portion;
a threshold between said non-flexible portion and said flexible portion is located closer to said top end than said bottom end;
said upper end of said handle receiving said bottom end of said tube;
said mounting head has an outer surface and a top surface and a bottom surface;
said outer surface is continuously arcuate about a center of said mounting head such that said mounting head has a disk shape;
said top end of said tube is attached to said outer surface of said mounting head;
said handle has a dividing wall being positioned within said handle; and
said dividing wall is spaced downwardly from said upper end of said handle having said dividing wall lying on a plane being oriented parallel to said upper end.

3. The device according to claim 2, wherein said drive unit comprises:
a motor being mounted to said outside wall of said handle of said toothbrush such that said motor is positioned inside of said handle, said motor rotating in a first direction when said motor is turned on;
an output shaft being coupled to and extending upwardly from said motor such that said motor rotates said output shaft when said motor is turned on;
a first drive gear being attached to a distal end of said output shaft such that said output shaft rotates said first drive gear when said motor is turned on;
a second drive gear being rotatably attached to a bottom side of said dividing wall in said handle of said toothbrush, said second drive gear being strategically positioned to enmesh with said first drive gear such that said first drive gear rotates said second drive gear when said motor is turned on; and
a cylinder having a lower end and an upper end, said cylinder being positioned within said tube, said cylinder extending through said dividing wall in said handle such that said lower end is spaced downwardly from said dividing wall, said upper end extending through said outer surface of said mounting head such that said upper end of said cylinder is positioned inside of said mounting head, said cylinder being comprised of a flexible material, said lower end of said cylinder being open, said upper end of said cylinder being closed.

4. The device according to claim 5, wherein said drive unit includes:
a cam having a top side being coupled to said lower end of said cylinder such that said cam is spaced downwardly from said dividing wall having said cam being aligned with said second drive gear, said cam being spaced away from said second drive gear;
a first peg being coupled to and extending downwardly from a lower surface of said second drive gear, said first peg being offset from a center of said lower surface of said second drive gear;
a second peg being coupled to and extending downwardly from a lower surface of said cam, said second peg being offset from a center of said cam; and
a linkage being pivotally attached between said first peg and said second peg such that said cam is oscillated back and forth each time said second drive gear makes one full rotation thereby facilitating said cylinder to be partially rotated back and forth about an axis extending between said lower end and said upper end of said cylinder when said motor is turned on.

5. The device according to claim 4, wherein said drive unit includes:
a pair of forks, each of said pair of forks being coupled to and extending away from said upper end of said cylinder such that each of said pair of forks is positioned within said mounting head;
a drive disk being positioned within said mounting head, said drive disk having an aperture extending through an upper surface and a lower surface of said drive disk, said aperture being centrally located on said drive disk, said drive disk lying on a plane being oriented parallel to said bottom surface of said mounting head having said drive disk being spaced from said bottom surface of said mounting head; and
a finger being coupled to and extending upwardly from said upper surface of said drive disk, said finger being offset from said aperture in said drive disk, said finger being positioned between said pair of forks which are attached to said upper end of said cylinder, said pair of forks urging said finger to travel back and forth when said cylinder is rotated back and forth when said motor is turned on thereby facilitating said drive disk to rotate back and forth, said drive disk rotating said brushing head back and forth when said drive disk is rotated back and forth by said pair of forks.

6. The device according to claim 1, wherein:
said brushing head comprises:
a brush disk having an upper surface and a lower surface; and
a receiver being coupled to said upper surface of said brush disk having said receiver being centrally positioned on said upper surface, each of said plurality of bristles having a coupled end being coupled to said lower surface of said brush disk, said plurality of bristles being evenly spaced apart from each other and being distributed over a full area of said lower surface of said brush disk.
said drive unit includes:
a mounting head having a top surface and a bottom surface;
a drive disk being positioned in said mounting head, said drive disk having a lower surface and an aperture extending through said drive disk; and
coupler being coupled to and extending away from said lower surface of said drive disk and extending through said bottom surface of said mounting head such that said coupler is exposed with respect to said mounting head, said coupler releasably engaging said receiver on said brush disk for releasably attaching said brushing head to said mounting head; and
said ejection unit comprises:
an ejection shaft extending through said top surface and said bottom surface of said mounting head such that a first end of said ejection shaft is spaced from said top surface and a second end of said ejection shaft is positioned in said coupler of said drive unit, said ejection shaft extending through said aperture in said drive disk; and
a biasing member being positioned around said ejection shaft having said biasing member being located within said mounting head, said biasing member biasing said ejection shaft to travel in a first direction such that said second end of said ejection shaft is spaced from said upper surface of said brush disk, said first end of said ejection shaft being depressible such that said ejection shaft is urged to travel in a second direction having said second end of said ejection shaft pressing against said brush disk thereby uncoupling said receiver from said coupler for removing said brushing head from said mounting head.

7. The device according to claim 1, wherein said straightening unit comprises:
a lever being movably integrated into an outside wall of said handle wherein said lever is configured to be manipulated by the user, said lever having an arm extending into an interior of said handle, said arm being perpendicularly oriented with said lever, said lever having a pivot point located at an intersection between said lever and said arm, said pivot point being pivotally attached to said outside wall of said handle, said arm having a lobe extending downwardly from said arm; and
a biasing member being attached between said lobe on said arm and an attachment point located on an interior surface of said outside wall of said handle such that said biasing member biases said lever into a first position, said lever being compressible against said outside wall of said handle having said lever pivoting on said pivot point thereby urging said arm to pivot upwardly when said lever is urged into a second position.

8. The device according to claim 7, wherein:
said drive unit includes a cylinder being positioned within said tube of said toothbrush;
said tube has a non-flexible portion and a flexible portion;
said straightening unit includes a member being comprised of a rigid material;
said member has a coupled end and a free end;
said member is positioned within said cylinder of said drive unit;
said coupled end of said member is attached to a distal end of said arm on said lever;
said member has a ball being attached to said free end of said member thereby reducing friction between said ball and an interior surface of said cylinder of said drive unit; and
said ball is aligned with said threshold between said flexible portion of said tube and said non-flexible portion of said tube when said lever is biased into said first position such that said flexible portion of said tube is enabled to be flexible.

9. The device according to claim 8, wherein said member is urged to travel upwardly in said cylinder when said lever is urged into said second position having said ball travelling into said flexible portion of said tube thereby facilitating said member to straighten said flexible portion.

10. The device according to claim 3, further comprising:
a pair of control buttons;
each of said pair of control buttons is movably integrated into said outside wall of said handle of said toothbrush thereby facilitating said pair of control buttons to be manipulated;
each of said pair of control buttons is electrically coupled to said motor;
said pair of control buttons includes an on button and an off button;
said motor is turned on when said on button is depressed; and
said motor is turned off when said off button is depressed.

11. The device according to claim 3, further comprising a power supply being integrated into said handle of said toothbrush, said power supply being electrically coupled to said motor, said power supply comprising:
a rechargeable battery being positioned within said handle of said toothbrush, said rechargeable battery being electrically coupled to said motor; and
a charge port being recessed into a bottom end of said handle of said toothbrush wherein said charge port is configured to insertably receive a charge cord, said charge port being electrically coupled to said rechargeable battery for charging said rechargeable battery.

12. A flexible electronic toothbrush device for facilitating a physically limited user to brush both the front side and the back side of the user's teeth without requiring the user to position the user's shoulder at orientations that the user cannot achieve, said device comprising:
a toothbrush having a handle and a tube extending away from said handle and a mounting head attached to said tube, said tube having a flexible portion being comprised of a resiliently flexible material thereby facilitating said flexible portion of said tube to be biased into a gentle curve with respect to a non-flexible portion of said tube which is comprised of a rigid material, said handle having an outer wall and an upper end, said outer wall tapering inwardly adjacent to said upper end such that said upper end defines a conical shape, said handle being substantially hollow, said upper end being open, said tube having a bottom end and a top end, said bottom end being associated with said non-flexible portion, said top end being associated with said flexible portion, a threshold between said non-flexible portion and said flexible portion being located closer to said top end than said bottom end, said upper end of said handle receiving said bottom end of said tube, said mounting head having an outer surface and a top surface and a bottom surface, said outer surface being continuously arcuate about a center of said mounting head such that said mounting head has a disk shape, said top end of said tube being attached to said outer surface of said mounting head, said handle having a dividing wall being positioned within said handle, said dividing wall being spaced downwardly from said upper end of said handle having said dividing wall lying on a plane being oriented parallel to said upper end;
a brushing head being removably attachable to said mounting head, said brushing head having a plurality of bristles being disposed on said brushing head wherein said plurality of bristles is configured to be employed for brushing a user's teeth, said brushing head comprising:
a brush disk having an upper surface and a lower surface; and
a receiver being coupled to said upper surface of said brush disk having said receiver being centrally positioned on said upper surface, each of said plurality of bristles having a coupled end being coupled to said lower surface of said brush disk, said plurality of bristles being evenly spaced apart from each other and being distributed over a full area of said lower surface of said brush disk;
a drive unit being integrated into said toothbrush, said drive unit being in mechanical communication with said brushing head when said brushing head is removably attached to said mounting head, said drive unit generating an oscillating motion when said drive unit is turned on thereby facilitating said brushing head to be rotated back and forth wherein said plurality of bristles is configured to brush the user's teeth in a motion preferred by dental health professionals, said drive unit comprising:
a motor being mounted to said outside wall of said handle of said toothbrush such that said motor is positioned inside of said handle, said motor rotating in a first direction when said motor is turned on;
an output shaft being coupled to and extending upwardly from said motor such that said motor rotates said output shaft when said motor is turned on;
a first drive gear being attached to a distal end of said output shaft such that said output shaft rotates said first drive gear when said motor is turned on;
a second drive gear being rotatably attached to a bottom side of said dividing wall in said handle of said toothbrush, said second drive gear being strategically positioned to enmesh with said first drive gear such that said first drive gear rotates said second drive gear when said motor is turned on;
a cylinder having a lower end and an upper end, said cylinder being positioned within said tube, said cylinder extending through said dividing wall in said handle such that said lower end is spaced downwardly from said dividing wall, said upper end extending through said outer surface of said mounting head such that said upper end of said cylinder is positioned inside of said mounting head, said cylinder being comprised of a flexible material, said lower end of said cylinder being open, said upper end of said cylinder being closed;
a cam having a top side being coupled to said lower end of said cylinder such that said cam is spaced downwardly from said dividing wall having said cam being aligned with said second drive gear, said cam being spaced away from said second drive gear;
a first peg being coupled to and extending downwardly from a lower surface of said second drive gear, said first peg being offset from a center of said lower surface of said second drive gear;
a second peg being coupled to and extending downwardly from a lower surface of said cam, said second peg being offset from a center of said cam;
a linkage being pivotally attached between said first peg and said second peg such that said cam is oscillated back and forth each time said second drive gear makes one full rotation thereby facilitating said cylinder to be partially rotated back and forth about an axis extending between said lower end and said upper end of said cylinder when said motor is turned on;
a pair of forks, each of said pair of forks being coupled to and extending away from said upper end of said cylinder such that each of said pair of forks is positioned within said mounting head;
a drive disk being positioned within said mounting head, said drive disk having an aperture extending through an upper surface and a lower surface of said drive disk, said aperture being centrally located on said drive disk, said drive disk lying on a plane being oriented parallel to said bottom surface of said mounting head having said drive disk being spaced from said bottom surface of said mounting head;
a coupler being coupled to and extending away from said lower surface of said drive disk and extending through said bottom surface of said mounting head such that said coupler is exposed with respect to said mounting head, said coupler releasably engaging said receiver on said brush disk for releasably attaching said brushing head to said mounting head; and
a finger being coupled to and extending upwardly from said upper surface of said drive disk, said finger being offset from said aperture in said drive disk, said finger being positioned between said pair of forks which are attached to said upper end of said cylinder, said pair of forks urging said finger to travel back and forth when said cylinder is rotated back and forth when said motor is turned on thereby facilitating said drive disk to rotate back and forth, said drive disk rotating said brushing head back and forth when said drive disk is rotated back and forth by said pair of forks;
an ejection unit being movably integrated into said mounting head, said ejection unit being in mechanical communication with said brushing head when said brushing head is removably attached to said mounting head, said ejection unit being urgeable into an ejecting condition such that said brushing head is disengaged from said mounting head, said ejection unit comprising:
an ejection shaft extending through said top surface and said bottom surface of said mounting head such that a first end of said ejection shaft is spaced from said top surface and a second end of said ejection shaft is positioned in said coupler of said drive unit, said ejection shaft extending through said aperture in said drive disk;
a biasing member being positioned around said ejection shaft having said biasing member being located within said mounting head, said biasing member biasing said ejection shaft to travel in a first direction such that said second end of said ejection shaft is spaced from said upper surface of said brush disk, said first end of said ejection shaft being depressible such that said ejection shaft is urged to travel in a second direction having said second end of said ejection shaft pressing against said brush disk thereby uncoupling said receiver from said coupler for removing said brushing head from said mounting head;
a straightening unit being movably integrated into said toothbrush, said straightening unit being in mechanical communication with said tube, said straightening unit being actuatable into a straightening condition such that said flexible portion of said tube is straightened wherein said straightening unit is configured to orient said brushing head at a preferred orientation for brushing the user's teeth without requiring the user to position their shoulder in an orientation that the user cannot achieve, said straightening unit being biased into an un-straightening condition, said straightening unit comprising:
a lever being movably integrated into said outside wall of said handle wherein said lever is configured to be manipulated by the user, said lever having an arm extending into an interior of said handle, said arm being perpendicularly oriented with said lever, said lever having a pivot point located at an intersection between said lever and said arm, said pivot point being pivotally attached to said outside wall of said handle, said arm having a lobe extending downwardly from said arm;
a biasing member being attached between said lobe on said arm and an attachment point located on an interior surface of said outside wall of said handle such that said biasing member biases said lever into a first position, said lever being compressible against said outside wall of said handle having said lever pivoting on said pivot point thereby urging said arm to pivot upwardly when said lever is urged into a second position; and
a member being comprised of a rigid material, said member having a coupled end and a free end, said member being positioned within said cylinder of said drive unit, said coupled end of said member being attached to a distal end of said arm on said lever, said member having a ball being attached to said free end of said member thereby reducing friction between said ball and an interior surface of said cylinder of said drive unit, said ball being aligned with said threshold between said flexible portion of said tube and said non-flexible portion of said tube when said lever is biased into said first position such that said flexible portion of said tube is enabled to flex, said member being urged to travel upwardly in said cylinder when said lever is urged into said second position having said ball travelling into said flexible portion of said tube thereby facilitating said member to straighten said flexible portion;
a pair of control buttons, each of said pair of control buttons being movably integrated into said outside wall of said handle of said toothbrush thereby facilitating said pair of control buttons to be manipulated, each of said pair of control buttons being electrically coupled to said motor, said pair of control buttons including an on button and an off button, said motor being turned on when said on button is depressed, said motor being turned off when said off button is depressed;
a power supply being integrated into said handle of said toothbrush, said power supply being electrically coupled to said motor, said power supply comprising:
a rechargeable battery being positioned within said handle of said toothbrush, said rechargeable battery being electrically coupled to said motor; and
a charge port being recessed into a bottom end of said handle of said toothbrush wherein said charge port is configured to insertably receive a charge cord, said charge port being electrically coupled to said rechargeable battery for charging said rechargeable battery.
